(19) United States
(12) Patent Application Publication
(10) Pub. No.: US 2024/0416706 A1
(43) Pub. Date: Dec. 19, 2024

(54) METHOD FOR OPERATING A PNEUMATIC SYSTEM, AND PNEUMATIC SYSTEM WITH COMPRESSED AIR SUPPLY SYSTEM AND AIR SPRING SYSTEM

(71) Applicant: ZF CV Systems Europe BV, Brussels (BE)

(72) Inventor: Uwe Stabenow, Laatzen (DE)

(21) Appl. No.: 18/814,184

(22) Filed: Aug. 23, 2024

Related U.S. Application Data
(63) Continuation of application No. PCT/EP2023/054166, filed on Feb. 20, 2023.

(30) Foreign Application Priority Data
Mar. 1, 2022 (DE) 10 2022 104 828.4

(51) Int. Cl. B60G 17/052

(52) U.S. Cl. CPC B60G 17/0526; B60G 17/0528; B60G 2400/5122; B60G 2500/203

(57) ABSTRACT

A method is for operating a pneumatic system having a compressed air supply and an air spring arrangement, which is pneumatically connected to the compressed air supply, for a vehicle. Before the compressed air supply is vented, the compressed air supply is activated by the control device in such a way that compressed air is discharged from the air dryer and/or the air distributor module into a first air spring of the air spring arrangement with the exhaust valve closed and the compressor inactive. Compressed air from the air dryer and/or the air distributor module is initially discharged into an air spring ascertained to be the first air spring, and chronologically following the discharge of compressed air into the first air spring, compressed air remaining in the air dryer and/or the air distributor module is discharged into a second air spring of the air spring arrangement and/or an intermediate volume.

### CROSS-REFERENCE TO RELATED APPLICATIONS

This application is a continuation application of international patent application PCT/EP2023/054166, filed Feb. 20, 2023, designating the United States and claiming priority from German application 10 2022 104 828.4, filed Mar. 1, 2022, and the entire content of both applications is incorporated herein by reference.

### TECHNICAL FIELD

The disclosure relates to a method for operating a pneumatic system having a compressed air supply installation and an air spring installation, which has air springs and is pneumatically connected to the compressed air supply installation, for a vehicle. The disclosure also relates to a pneumatic system and a vehicle, in particular a passenger car.

### BACKGROUND

The components of a compressed air supply installation are connected to one another in such a way that, by controlling the compressed air supply installation with a control device, air can be drawn in from the surroundings by a compressing means, in particular a compressor, the drawn-in air can be dried by an air dryer and the dry compressed air can be conducted into the compressed air reservoir and/or into the air springs via an air distributor module. A pressure sensor is arranged and configured to measure the level of the pressure in the air distributor module and to provide a pressure sensor signal representing the level of the measured pressure to the control device. The control device can adjust the control of the compressed air supply installation on the basis of the measured pressure.

By filling the air springs, it is possible to raise a vehicle relative to the ground. When compressed air is conducted from the air springs into the surrounding atmosphere or into the compressed air reservoir, the vehicle can be lowered relative to the ground.

It is often desirable for a vehicle to be raised and lowered again relatively rapidly. In particular for off-road vehicles and sport utility vehicles (SUVs) with very powerful engines, it is often desirable to provide the vehicle with comparatively low ground clearance for high speeds on the road on the one hand, and comparatively high ground clearance for off-road use on the other. It is often also desirable to implement a change in ground clearance as rapidly as possible, which increases the requirements, in terms of rapidity, flexibility and reliability, of a compressed air supply installation. In order to meet the requirements mentioned above, correspondingly high pressures are typically required in the compressed air supply installation. The requirements for an electronically controlled air suspension (ECAS) for a vehicle therefore commonly include high intake and exhaust air flows combined with high pressures in the compressed air supply installation.

However, when the compressed air supply installation is vented comparatively rapidly high pressures in the compressed air supply installation may result in a high noise level, also referred to as a discharge bang. These noises are generally undesirable for vehicle users and are therefore reduced by the manufacturer, for example by using silencers. It is thus common practice to install in vehicles additional components which act to minimize a noise level when venting the compressed air supply installation.

In order, inter alia, to reduce the use of further components such as silencers in the vehicle, it has been proposed to reduce a noise level when venting the compressed air supply installation by controlling the compressed air supply installation accordingly.

A control means for a compressed air supply installation for venting air from an air spring installation is described, for example, in WO 2008/147850 A1. According to this document, in order to reduce noise when venting a gas suspension system, the air spring valves are initially to be opened and compressed air is thus to be applied to the air springs. It is then necessary to wait until a comparatively lower equilibrium pressure is established in the system. Only when equilibrium pressure has been established in the system is the exhaust valve opened and the gas suspension system vented. Venting is then to be carried out at reduced pressure.

DE 10 2016 123201 A1 describes that, in order to vent a compressor in at least two method steps, compressed air from the compressor is conducted into at least one air spring of an air spring installation and subsequently vented into the surroundings. For this purpose, it is proposed that venting begins in particular when a maximum pressure is reached. It is reported that this can result in a reduced pressure difference, for example approximately 8 bar rather than approximately 18 bar, when venting into the surroundings. This is said to offer the advantage that it is possible to vent into the surroundings with markedly less noise, due to the reduced discharge thud.

These approaches can be improved further. In particular, it is desirable to ensure a comparatively low venting noise when venting without excessively impairing the functionality of the pneumatic system when venting.

### SUMMARY

An object of the disclosure is to provide an improved or at least alternative method for operating a pneumatic system, and an improved or at least alternative pneumatic system. The disclosure is based in particular on the object of providing a method for operating a pneumatic system and a pneumatic system which at least partially eliminate or reduce the problems of the prior art.

Preferably, the disclosure provides a method for operating a pneumatic system and a pneumatic system in which a comparatively low venting noise is ensured without excessively impairing the functionality of the pneumatic system when venting. The disclosure is based in particular on the object of specifying a method and a pneumatic system which provides or makes it possible to achieve efficient pressure management when operating a pneumatic system for venting. A preferred pressure management is to have, to the greatest possible extent, no or only limited or reasonable to little effect on the driving characteristics of a vehicle. In particular, an object is to specify a method and a pneumatic system which allows a compressed air supply installation to be vented comparatively rapidly and at a low noise level. Preferably, it is to be possible to dispense with silencers or other components which reduce the venting noise level.

A method for operating a pneumatic system including a compressed air supply installation and an air spring installation, which has air springs and is pneumatically connected to the compressed air supply installation, for a vehicle, in particular for a passenger car, is proposed.

The compressed air supply installation has a pneumatic main line and an air dryer in the pneumatic main line, and the pneumatic main line has a compressing means port to a compressing means and a compressed air supply port to an air distributor module of the air spring installation.

The air spring installation of the pneumatic system has a number of air springs, which are pneumatically connected via a gallery of the air spring installation.

The air spring installation of the pneumatic system may optionally have the air distributor module. Alternatively, the air distributor module could also form part of the compressed air supply installation.

The compressing means of the compressed air supply installation may, for example, be formed as a compressor.

The pneumatic system has a control device for controlling the compressed air supply installation and the air spring installation.

In the method, before the compressed air supply installation is vented, in particular into the surroundings of the compressed air supply installation or into the atmosphere, the compressed air supply installation is activated by the control device in such a way that compressed air is discharged from the air dryer and/or the air distributor module into a first air spring with the exhaust valve closed and the compressing means inactive.

According to the disclosure, it is provided in the method that the first air spring is ascertained to be the air spring having the greatest pressure difference to the pressure in the air distributor module before compressed air is discharged from the air dryer and/or the air distributor module. This is in particular the air spring with the lowest air spring pressure or bellows pressure in the air spring.

According to the disclosure, in the method, when the first air spring has been ascertained, compressed air is initially discharged from the air dryer and/or the air distributor module into the air spring ascertained to be the first air spring.

According to the disclosure, it is further provided in the method that, chronologically following the discharge of compressed air into the first air spring, compressed air remaining in the air dryer and/or the air distributor module is discharged into a second air spring of the air spring installation and/or an intermediate volume.

In particular, in order to reduce the pressure in the air dryer and/or the air distributor module, chronologically following the discharge of compressed air into the first air spring, compressed air remaining in the air dryer and/or the air distributor module is discharged into a second air spring of the air spring installation.

The method according to the disclosure relates to an operating situation which directly precedes the venting of the compressed air supply installation. Accordingly, the compressed air supply installation has already been filled and the filling process has been completed. There is therefore a largely constant compressed air quantity in the compressed air supply installation.

Venting the compressed air supply installation into the surroundings or atmosphere is intended to reduce the compressed air quantity present in the compressed air supply installation. In an operating situation before the compressed air supply installation is vented into the surroundings or atmosphere, the compressing means is preferably inactive, a storage means valve of a compressed air reservoir is closed and/or, if present, an intake valve is closed.

The disclosure is based on the consideration that it is in principle advantageous if silencers for reducing the noise level when venting a compressed air supply installation can be dispensed with completely or at least to the greatest possible extent. At least, it is advantageous if additional silencers can be dispensed with despite the high requirements for compressed air supply installations, for example in respect of the option to raise and lower the vehicle rapidly, which is usually only achievable with high pressures in the compressed air supply installation.

In this case, the reduction in the noise level when venting is substantially achieved by controlling the compressed air supply installation accordingly. Completely or at least largely dispensing with silencers would also have the advantage of considerable cost savings.

The method according to the disclosure provides such control, which makes it possible to completely dispense with silencers or at least dispense with the latter to the greatest possible extent.

This is achieved by the method according to the disclosure in that compressed air is discharged into the air spring with a pressure which, in comparison with the pressures in the remaining air springs, has the greatest pressure difference to the pressure in the air dryer and/or in the air distributor module. This makes it possible to markedly lower the pressure in the air dryer and/or in the air distributor module before venting. In particular, the pressure at the exhaust can be lowered to such an extent that silencers can be dispensed with completely or at least to the greatest possible extent.

The compressed air supply installation operated in accordance with the method according to the disclosure may be an open system or a closed system.

An open system is distinguished by the fact that air is drawn in by the compressing means from the surrounding atmosphere and conveyed into air springs of the vehicle, for example in order to raise the vehicle. In an open system, the compressing means draws in air in particular only from the surroundings or discharges air into the surroundings. However, a compressed air reservoir may also be provided in an open system, compressed air being exchangeable between this compressed air reservoir and one or more air springs and/or the compressing means to control the pressure in the compressed air supply installation.

In a closed system, air is conveyed back and forth between a compressed air reservoir and the air springs in order to raise or lower the vehicle. It may be necessary to top up with air from outside even in a closed system. It is therefore common practice for a compressed air supply installation which is a closed system or is operated as a closed system also to have an intake with an intake valve.

In both an open system and a closed system, air flows under pressure through an air dryer when the compressed air supply installation is filled.

The gallery of the air spring installation may also be configured as part of the air distributor module.

Filling the air springs with compressed air means, in particular, that compressed air is applied to the bellows of the air springs.

Preferably, excess compressed air from the air dryer and/or the air distributor module is distributed to the air springs. The compressed air is distributed by applying compressed air to the air springs in a chronologically consecutive manner.

By initially applying compressed air to the air spring which the greatest pressure difference to the pressure in the air distributor module, the pressure in the air dryer and/or the air distributor module can already be lowered markedly when compressed air is applied to the first air spring. The remaining compressed air is then divided among the remaining air springs. Preferably, the order of the remaining air springs is selected in such a way that compressed air is applied in each case to the air spring having the greatest pressure difference to the pressure in the air distributor module at any given time.

This procedure can be repeated until the excess compressed air from the air dryer and/or the air distributor module has been distributed to the air springs. The compressed air supply installation and in particular the air dryer and/or the air distributor module can then be vented at a comparatively lower pressure, so that the noise level is comparatively lower, even if silencers have been dispensed with completely or at least to the greatest possible extent.

The expression “in a chronologically consecutive manner” or “chronologically following” means that compressed air from the air dryer and/or the air distributor module is applied to the air springs individually in a directly consecutive manner or in a directly consecutive manner in at least two groups of at least two air springs, that is, without further intermediate steps, such as, for example, further venting or filling. In this process, for example the air spring valve of a first air spring is opened in order to apply compressed air from the air dryer and/or the air distributor module to the latter. The air spring valve of this air spring is subsequently closed again. When the air spring valve of this air spring is closed, the air spring valve of the next air spring is opened in order to apply compressed air to the latter. The procedure is applied consecutively for each of the air springs in order to apply compressed air from the air dryer and/or the air distributor module to these air springs individually in a chronologically consecutive manner. Therefore if, in the method step, compressed air from the air dryer and/or the air distributor module is applied to air springs individually in a chronologically consecutive manner, compressed air is only applied to one of the air springs at any time and the air spring valves of the remaining air springs are closed during this time.

In the method, it can be preferred that, after compressed air has been applied to the first and second air springs, the residual compressed air from the air dryer and/or the air distributor module is vented into the surrounding atmosphere through the exhaust with the air spring valves closed. Since the pressure at the exhaust can be reduced by applying compressed air to at least one of the air springs, it is possible to vent air into the surrounding atmosphere, with the air spring valves closed, at a markedly reduced noise level. In particular, the pressure can be lowered to such an extent that silencers can be dispensed with completely or at least to the greatest possible extent.

In the method, it can be further preferred that compressed air is discharged from the air dryer and/or the air distributor module into the intermediate volume chronologically before compressed air is discharged from the air dryer and/or the air distributor module through the exhaust into the surrounding atmosphere. The intermediate volume is filled in particular directly before the air dryer and/or the air distributor module is vented. That is, the method step of filling the intermediate volume is immediately followed by the method step of venting the air dryer and/or the air distributor module. This allows the pressure in the air dryer and/or the air distributor module to be lowered further still and, in particular, to below the level of the pressure in the air springs.

Preferably, compressed air from the air dryer and/or the air distributor module is applied to the first and second air springs if the pressure sensor measures a level of the pressure in the air distributor module of less than 12 bar, in particular less than 11 bar, preferably less than 10 bar, particularly preferably between 0 bar and 12 bar. Accordingly, the method according to the disclosure makes it possible in particular to vent air at low or medium pressures at a further reduced noise level. This makes it possible to completely or at least partially dispense with silencers.

In the method, it may optionally be provided that the compressed air supply installation is activated by the control device in such a way that the compressed air is discharged into the air spring having the greatest pressure difference to the pressure in the air dryer and/or in the air distributor module in a specified compressed air quantity and/or for a specified period of time and/or to achieve a predefined pressure drop in the air distributor module. The air spring is therefore filled only with a specific compressed air quantity, which is in particular determined in such a way that there is no, or at least little, change in the driving characteristics of a vehicle when the air spring is filled.

The specified compressed air quantity may be calculated, for example, from the measured pressures of the pressure sensor, the known air dryer and air distributor module volume and the air spring volumes.

The compressed air quantity and/or the period of time may, for example, be selected in such a way that the vehicle is raised only by a comparatively small amount, for example by one centimeter or less, by filling the air spring.

Discharging compressed air from the air dryer in accordance with a predefined pressure drop in the air distributor module may, for example, be implemented in such a way that a specific pressure drop in the air distributor module is discharged in each case into an air spring. For example, the pressure in the air distributor module may be measured by the pressure sensor and one of the air springs may be filled with compressed air in each case for the period of time required to achieve a predefined pressure drop. For example, each of the air springs may be filled with compressed air from the pressure volume to achieve a pressure drop of 1 bar in the air distributor module.

A predefined period of time during which an air spring is filled with compressed air may, for example, be between 50 ms and 400 ms, for example 100 ms.

In the method, it may in particular be provided that, after filling with compressed air the air spring which, in comparison with the pressures in the remaining air springs, has the greatest pressure difference to the pressure in the air dryer and/or in the air distributor module:
compressed air from the air dryer and/or the air distributor module is subsequently discharged into the air spring, of the remaining air springs, with a pressure which, in comparison with the pressures of the two remaining air springs, has the greatest difference to the pressure in the air dryer and/or in the air distributor module, and
compressed air from the air dryer and/or the air distributor module is subsequently discharged into the air spring, of the two remaining air springs, with a pressure which, in comparison with the pressure of the other remaining air spring, has the greatest difference to the pressure in the air dryer and/or in the air distributor module, and
compressed air from the air dryer and/or the air distributor module is finally discharged into the remaining air spring to which compressed air has not yet been applied.

The air springs are thus filled with compressed air consecutively, wherein, of the air springs, the air spring with a pressure having the greatest difference to the pressure in the air dryer and/or in the air distributor module is always the air spring that is filled.

Preferably, in the method, in accordance with the order of the air springs ascertained based on the greatest pressure difference to the pressure in the air dryer and/or in the air distributor module, compressed air from the air dryer and/or the air distributor module is applied to the air springs again in the same order in a chronologically consecutive manner, in a specified compressed air quantity and/or for a predefined period of time in each case. Compressed air is preferably applied to the air springs consecutively until the pressure at the exhaust has a value which in particular is below a specified threshold.

For example, in the method, a compressed air quantity and/or period of time may be individually specified for each of the air springs, and the compressed air supply installation can be activated by the control device in such a way that compressed air is discharged into the corresponding one of the air springs in the compressed air quantity specified in each case and/or for the specified period of time. Compressed air may therefore be applied to the air springs in different compressed air quantities in each case and/or for different periods of time. The compressed air quantity and/or the period of time may be selected for each of the air springs, for example, depending on the pressure prevailing in the respective air spring.

As an alternative to filling only one of the air springs at any time, it may be provided in the method that compressed air is applied simultaneously to the two air springs of a front axle or of a rear axle of the vehicle. Such a procedure may for example be advantageous if the air springs of a front axle or a rear axle are at substantially the same pressure.

Preferably, the first air spring is located on a different vehicle axle to the second air spring, and compressed air is applied to the first air spring and the second air spring together in each case with further air springs of the same vehicle axle.

When the air springs of a front axle or a rear axle are filled simultaneously with compressed air, it may be advantageous
if the pressure of a front axle of the vehicle is greater than the pressure of the air springs of a rear axle of the vehicle,
for compressed air to be discharged from the air springs of the front axle into the air springs of the rear axle before venting.

Alternatively, it may be provided that,
if the pressure of the air springs of a of the vehicle is greater than the pressure of the air springs of a front axle of the vehicle,
compressed air is discharged from the air springs of the rear axle into the air springs of the front axle before venting.

In the method it may also optionally be provided that the compressed air supply installation is activated by the control device in such a way that the exhaust valve is opened and closed again at predefined intervals, so that the compressed air supply installation is vented in steps through the exhaust. This allows the compressed air to be emitted in portions into the surrounding atmosphere in small compressed air quantity units, which can further reduce the noise level when venting.

Alternatively or additionally, in the method it may also be provided that the compressed air supply installation is activated by the control device in such a way that the compressing means stores a portion of the compressed air while compressed air is being vented through the exhaust, so that the compressed air quantity actually emitted into the surrounding atmosphere is comparatively smaller. By thus emitting a comparatively smaller compressed air quantity into the surrounding atmosphere, the noise level can be additionally further reduced when venting.

The compressed air supply installation may also include an auxiliary storage means and, in the method, before the compressed air supply installation is vented, compressed air from the air dryer and/or the air distributor module can be applied, as well as to the air springs, to the auxiliary storage means in a specified compressed air quantity and/or for a predefined period of time. This also makes it possible to further reduce the compressed air quantity emitted into the surrounding atmosphere.

In a second aspect, the object is achieved by a pneumatic system for a vehicle, in particular for a passenger car. The pneumatic system includes a compressed air supply installation and an air spring installation, which has the air springs and is pneumatically connected to the compressed air supply installation, wherein the pneumatic system has a control device for controlling the compressed air supply installation and the air spring installation. The pneumatic system is configured according to the disclosure to carry out the method described above.

Preferably, the compressed air supply installation has the following components: a compressing means, an air distributor module, an air dryer, an intake with an intake valve and an exhaust with an exhaust valve for filling with air from the surrounding atmosphere and/or for venting into the surrounding atmosphere, and a pressure sensor for detecting a level of a pressure in the air distributor module. The control device is configured to control, at least depending on the pressure signal, the compressed air supply installation and the air spring installation to carry out the method.

The disclosure also presents a vehicle having a pneumatic system according to the disclosure. The vehicle is in particular a passenger car.

### BRIEF DESCRIPTION OF DRAWINGS

The invention will now be described with reference to the drawings wherein:

FIG. 1A schematically shows a compressed air supply installation, which is pneumatically connected to an air spring installation and in which the intake and exhaust are realized separately from each other;

FIG. 1B schematically shows a compressed air supply installation, which is pneumatically connected to an air spring installation and in which the intake and exhaust are realized via a common port;

FIG. 2 schematically shows a flowchart for a method for operating a compressed air supply installation;

FIG. 3 shows a graph which indicates the compressed air quantity emitted into the surrounding atmosphere relative to the pressure at the exhaust for different throttle diameters of the air dryer;

FIG. 4 schematically shows a flowchart for a method for operating a compressed air supply installation, in which the air spring which, in comparison with the pressures in the remaining air springs, has the greatest pressure difference to the pressure in the air dryer and/or in the air distributor module, is filled with compressed air before venting;

FIG. 5A schematically shows a compressed air supply installation, which is pneumatically connected to an air spring installation and is realized as an open system;

FIG. 5B schematically shows the compressed air supply installation illustrated in FIG. 5A and depicts the diversion of compressed air into the air spring is filled with compressed air which, in comparison with the pressures in the remaining air springs, has the greatest pressure difference to the pressure in the air dryer and/or in the air distributor module;

FIG. 5C schematically shows the compressed air supply installation illustrated in FIG. 5A and depicts the diversion of compressed air into the two air springs of the rear axle of a vehicle;

FIG. 5D schematically shows the compressed air supply installation illustrated in FIGS. 5A to 5C and depicts the compressed air supply installation being vented into the surrounding atmosphere;

FIG. 5E schematically shows the compressed air supply installation illustrated in FIGS. 5A to 5D and depicts air being vented into the surrounding atmosphere, wherein a portion of the compressed air is stored in the compressing means during venting;

FIG. 6A shows a compressed air supply installation which is illustrated using circuit symbols and is pneumatically connected to air springs of an air spring installation via air spring valves;

FIG. 6B shows the compressed air supply installation illustrated in FIG. 6A, wherein the air spring valve of a first air spring is open in order to divert compressed air into the first air spring;

FIG. 6C shows the compressed air supply installation illustrated in FIG. 6A, wherein the air spring valve of a second air spring is open in order to divert compressed air into the second air spring;

FIG. 6D shows the compressed air supply installation illustrated in FIG. 6A, wherein the air spring valve of a third air spring is open in order to divert compressed air into the third air spring;

FIG. 6E shows the compressed air supply installation illustrated in FIGS. 6A to 6D, wherein all air spring valves are closed and the relay valve and the exhaust valve for venting the compressed air supply installation are open;

FIG. 7 shows a logic diagram which represents a sequence when filling the air springs with compressed air; and,

FIG. 8 schematically shows a compressed air supply installation, which is pneumatically connected to an air spring installation, is realized as a closed system and has an auxiliary storage means.

### DETAILED DESCRIPTION

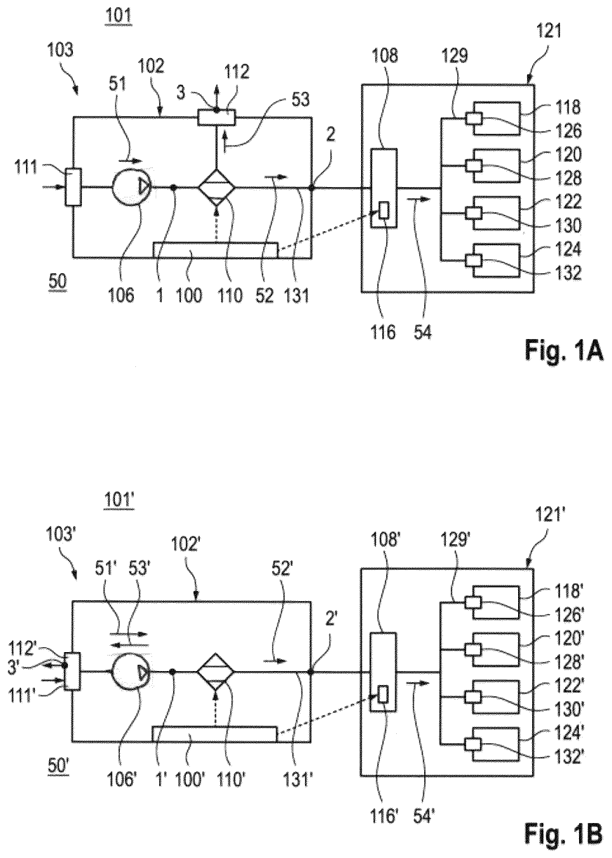

FIG. 1A schematically shows a compressed air supply installation 102, which is pneumatically connected to an air spring installation 121, in which a compressing means port 1 and an exhaust 3 are realized separately from each other.

The compressed air supply means 102 and the air spring installation 121 are components of a vehicle 101 and may be used for example to raise or lower the vehicle 101 relative to the ground. The compressed air supply installation 102 and the air spring installation 121 together form a pneumatic system 103.

The compressed air supply installation 102 includes the compressing means port 1 with an intake valve 111, and an exhaust 3 with an exhaust valve 112. A pneumatic main line 131 extends between the compressing means port 1 and the compressed air supply port 2. The compressed air supply installation 102 also includes a compressing means 106 which is pneumatically connected to the compressing means port 1 and which acts to draw in and compress air 51 from the surrounding atmosphere 50 and to transfer the air which has been compressed to an air dryer 110 as compressed air 52. In this embodiment, the compressing means 106 is formed as a compressor. The air dryer 110 is configured to dry air 51 drawn in from the surrounding atmosphere 50 and to transfer it to an air distributor module 108. The air dryer 110 is also pneumatically connected to the exhaust 3, through which the compressed air supply installation 102 can be vented.

The air distributor module 108 forms part of the air spring installation 121 and may also include the gallery 129. The air distributor module 108 includes a pressure sensor 116 for detecting a level of the pressure in the air distributor module 108. The air distributor module 108 acts to transfer compressed air 54 to the gallery 129.

The compressed air supply installation 102 further includes a control device 100 for controlling the compressed air supply installation 102. The control device 100 is connected to the pressure sensor 116 via a data connection 55. A pressure sensor signal, which represents the level of a pressure detected, can be transmitted to the control device 100 via the data connection 55. The control device 100 is also connected to the compressing means 106 via a control line 56 in order to control the compressing means 106. For example, the control device 100 can control the compressing means 106 on the basis of a pressure level, which is detected by the pressure sensor 116 and has been transmitted, by means of a pressure sensor signal, by the pressure sensor 116 to the control device 100 via the data connection 55.

The air spring installation 121 includes four air springs 118, 120, 122, 124, which can be filled with compressed air 54 via the gallery 129 in order to raise the vehicle 101. When compressed air 54 is discharged from the air springs 118, 120, 122, 124 into the compressed air supply installation 102, the vehicle 101 is lowered relative to the ground.

The air springs 118, 120, 122, 124 are each pneumatically connected to the air distributor module 108 via the air spring valves 126, 128, 130, 132 via the gallery 129. When the air spring valves 126, 128, 130, 132 are open, the air springs 118, 120, 122, 124 can be filled with or evacuated of compressed air 54 accordingly.

FIG. 1B schematically shows a compressed air supply installation 102′, which is pneumatically connected to an air spring installation 121′ and in which a separate pneumatic line is not provided for the exhaust 3′. The compressed air supply installation 102′ and the air spring installation 121′ together form a pneumatic system 103′.

The compressed air supply installation 102 described in relation to FIG. 1A differs in particular from the compressed air supply installation 102′ in that the compressing means port 1 and the exhaust 3 are realized separately from one another in the compressed air supply installation 102.

Accordingly, the air dryer 110′ of the compressed air supply installation 102′ is pneumatically connected to the compressing means 106′ and the air distributor module 108′. The compressing means 106′ is in turn pneumatically connected to the compressing means port 1′ and the exhaust 3′ via a pneumatic line. Air 51′ drawn in from the surrounding atmosphere 50′ by the compressing means 106′ is accordingly conducted from the compressing means port 1′ to the air dryer 106′ and is dried by the latter. The air which has been compressed is transferred as compressed air 52′ to the air distributor module 108′. The compressed air 54′ can be transferred via the compressed air supply port 2′ from the air distributor module 108′ to the air spring installation 121′, which is pneumatically connected to the pressure supply installation 102′.

The air spring installation 121′ includes the air springs 118′, 120′, 122′, 124′, to which compressed air 52′ can be applied by opening the respective air spring valves 126′, 128′, 130′, 132′ in order thus to raise the vehicle c.

The compressed air supply installation 102′ includes a control device 100′, which is connected to a pressure sensor 116′ of the air distributor module 108′ via a data connection 55′. The pressure sensor 116′ is configured to measure a level of the pressure in the air distributor module 108′ and to transmit a pressure sensor signal, which represents the level detected of the pressure in the air distributor module 108′, to the control device 100′ via the data connection 55′. The control device 100′ is connected to the compressing means 106′ via a control line 56′ for controlling the compressing means 110′. The compressing means 106′ can be controlled by the control device 100′ on the basis of the level, measured by the pressure sensor 116′, of the pressure in the air distributor module 108′.

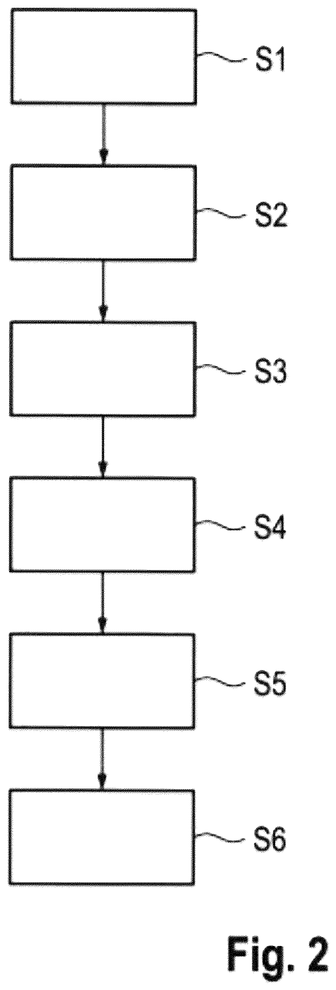

FIG. 2 schematically shows a flowchart for a method, known per se, for operating a compressed air supply installation. The method makes it possible in particular to reduce the pressure at the exhaust of the compressed air supply installation so that the compressed air supply installation can be vented at a comparatively lower pressure. Since venting is carried out at a comparatively lower pressure, the noise level generated when venting the compressed air supply installation is also comparatively lower.

In the method, a compressing means of the compressed air supply installation is initially set to idle mode (step S1) and the exhaust valve of an exhaust of the compressed air supply installation is closed (step S2). When the compressing means is in idle mode and the exhaust valve is closed, the air spring valves are opened (step S3). By opening the air spring valves, compressed air flows from the compressed air supply installation into the air springs of a pneumatic air spring installation which is connected to the compressed air supply installation. An equilibrium pressure is then established in the compressed air supply installation, this equilibrium pressure being comparatively lower than the pressure prevailing in the compressed air supply installation before the air spring valves were opened (step S4). After an equilibrium pressure has been established in the compressed air supply installation and the air spring installation, the air spring valves are closed again (step S5). In the method, the air spring valves are all opened and closed together. This raises the vehicle by applying compressed air to the air springs in one step, which can have a negative effect on the driving characteristics of the vehicle.

After the air spring valves have been closed again, the exhaust valve is opened (step S6) in order to vent the compressed air supply installation at a comparatively lower pressure at the exhaust.

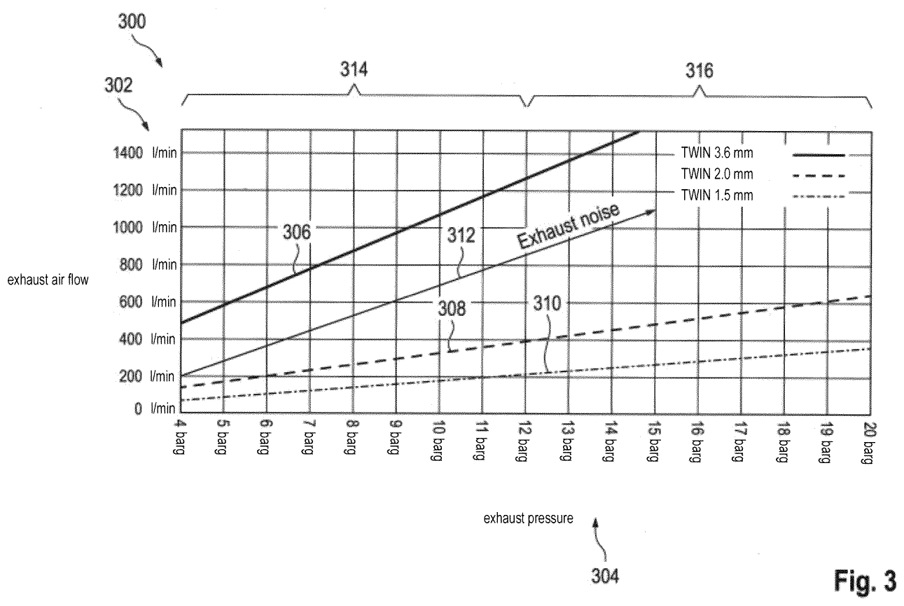

FIG. 3 shows a graph 300 which indicates the compressed air quantity 302 emitted into the surrounding atmosphere relative to the pressure at the exhaust 304, for different throttle diameters of an air dryer.

The graph 300 shows three curves 306, 308, 310, which show the increase in the compressed air quantity 302 in relation to the pressure 304 at the exhaust for different throttle diameters of an air dryer in each case.

All three curves 306, 308, 310 show a linear relationship between the level of the compressed air quantity 302 emitted as a function of the level of the pressure at the exhaust 304.

In the graph, the curve 306 represents the linear relationship between the level of the compressed air quantity 302 emitted as a function of the level of the pressure at the exhaust 304 for a throttle diameter of 3.6 mm.

The curve 308 represents the linear relationship between the level of the compressed air quantity 302 emitted as a function of the level of the pressure at the exhaust 304 for a throttle diameter of 2.0 mm.

The curve 310 represents the linear relationship between the level of the compressed air quantity 302 emitted as a function of the level of the pressure at the exhaust 304 for a throttle diameter of 1.5 mm.

In the graph, the increase in the noise level at the exhaust is also symbolically illustrated with an arrow 312. The arrow 312 indicates that, when venting a compressed air supply installation and, in particular, the air dryer and/or the air distributor module of the compressed air supply installation, as the compressed air quantity 302 emitted rises, accompanied by a correspondingly high pressure at the exhaust 304, the noise level at the exhaust also rises accordingly.

The illustrated pressure range of 4 bar to 20 bar can be divided into two pressure sub-ranges, wherein the first pressure sub-range 314 represents the range of 4 bar to 12 bar and the second pressure sub-range 316 represents the range of 12 bar to 20 bar. In particular in the pressure sub-range between 12 bar and 20 bar, venting the compressed air supply installation results in a comparatively high noise level. It is therefore preferable not to vent the compressed air supply installation when the pressure at the exhaust falls within this second pressure sub-range 316. If the pressure at the exhaust falls within the second pressure sub-range 316 and it is nevertheless necessary to vent the air dryer and/or the air distributor module in order to reduce the pressure prevailing there, it is therefore preferred to divert compressed air from the air dryer and/or the air distributor module into the air springs of an air spring installation in order thus to lower the pressure in the air dryer and/or the air distributor module to such an extent that the pressure at the exhaust falls within the first pressure sub-range 314. By filling the air springs with compressed air, the pressure at the exhaust can in particular be lowered to such an extent that no silencers, or at least silencers with smaller dimensions, are required for the noise level to fall below a specified threshold.

Accordingly, by pressurizing the air spring with a pressure which, in comparison with the pressures in the remaining air springs, has the greatest pressure difference to the pressure in the air dryer and/or in the air distributor module, the pressure in the first pressure sub-range 314 at the exhaust can be reduced to such an extent that silencers can be completely or at least partially dispensed with.

As soon as the pressure at the exhaust falls within the first pressure sub-range 314, the compressed air supply installation can be vented without generating a noise level which exceeds a critical, for example predefined, threshold.

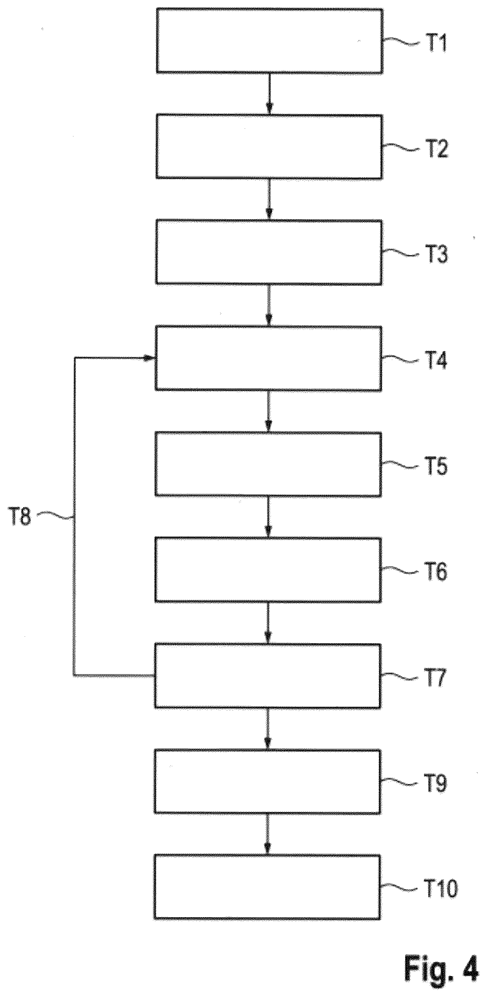

FIG. 4 schematically shows a flowchart for a method for operating a compressed air supply installation. In the method, before venting takes place, the air spring which, in comparison with the pressures in the remaining air springs, has the greatest pressure difference to the pressure in the air dryer and/or in the air distributor module, is filled with compressed air.

In the method, the compressing means of the compressed air supply installation is initially set to idle mode (step T1) and the exhaust valve of the exhaust of the compressed air supply installation is closed (step T2).

A control device, for example the control device of the compressed air supply installation, is used to specify or define a compressed air quantity in which and/or a period of time for which compressed air from the air dryer and/or the air distributor module of the compressed air supply installation is to be applied to the air springs of an air spring installation (step T3).

In the method, compressed air is initially applied to the air spring with a pressure which, in comparison with the pressures in the remaining air springs, has the greatest pressure difference to the pressure in the air dryer and/or in the air distributor module (step T4). The air spring is in particular filled with compressed air in a compressed air quantity specified for this air spring and/or for a period of time predefined for this air spring.

After the air spring valve of the air spring with the greatest pressure difference to the pressure in the air dryer and/or the air distributor module has been closed, the air spring valve of the air spring which, in comparison with the two remaining air springs, has the pressure with the greatest pressure difference to the pressure in the air dryer and/or the air distributor module, is opened (step T5). When the air spring valve of this second air spring is also closed, the air spring valve of the air spring with a pressure which, in comparison with the pressure of the remaining air spring, has the greater pressure difference to the pressure in the air dryer and/or in the air distributor module, is opened (step T6). Compressed air is subsequently applied to the remaining air spring (step T7).

An individual compressed air quantity and/or period of time can be specified for each of the air springs. Preferably, comparatively small compressed air quantities are applied to the air springs, so that applying compressed air to the air springs in succession has no, or at least little, effect on the driving characteristics of the vehicle. It is, however, possible that after compressed air has been applied to each of the air springs once in the compressed air quantity specified for the respective air spring and/or for the period of time predefined for the respective air spring, the pressure at the exhaust has not yet fallen below a specified threshold. In this case, compressed air is preferably applied to the air springs again in the same order (step T8).

A compressed air quantity and/or a period of time may also be specified for each of the air springs for the repeated application of compressed air to the air springs. The compressed air quantity and/or the period of time specified for the repeated application of compressed air to the air springs may differ from the compressed air quantity and/or period of time specified for the initial application of compressed air to the air springs.

After the air springs have been filled with compressed air and all air spring valves are closed, the compressing means of the compressed air supply installation can be reactivated (step T9) and the exhaust valve opened (step T10). The compressed air supply installation is then vented. A portion of the compressed air emitted into the surrounding atmosphere is stored in the activated compressing means, so that the compressed air quantity actually emitted into the surrounding atmosphere is comparatively lower.

Additionally or alternatively, it may be provided in the method that the exhaust valve of the compressed air supply installation is opened and closed multiple times during venting, for example at a specified frequency, so that the compressed air is emitted into the surrounding atmosphere in a plurality of steps. This can further lower the noise level generated when venting.

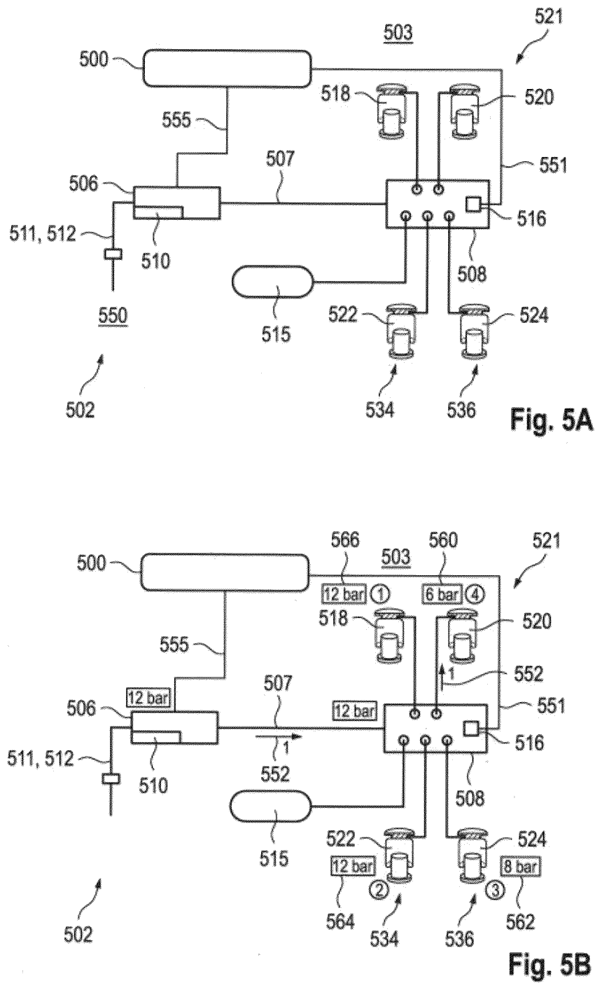

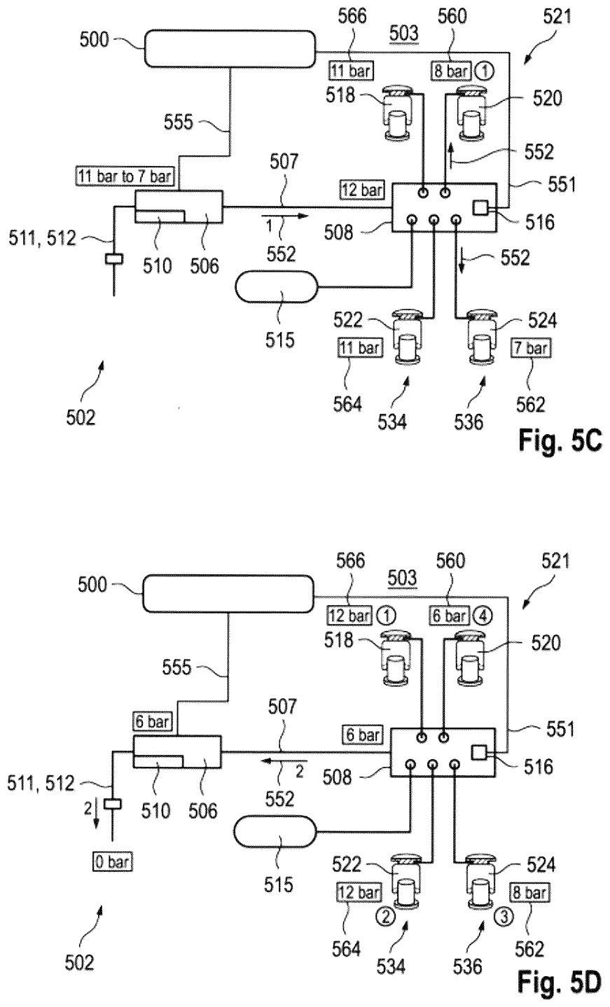

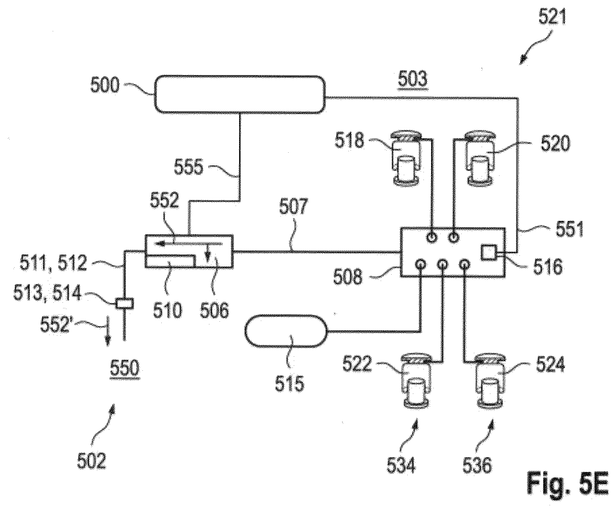

FIG. 5A schematically shows a compressed air supply installation 502, which is pneumatically connected to an air spring installation 521 and is realized as an open system.

The compressed air supply installation 502 includes an intake 511 and an exhaust 512, which are realized via a common port. The compressed air supply installation 502 also includes an air dryer 510 and a compressing means 506. When the compressing means 506 draws in air from the surrounding atmosphere 550, this air flows through the intake 511 and through the air dryer 510. The air dried by the air dryer 510 is conducted from the compressing means 506 as dry compressed air via a pneumatic main line 507 to the air distributor module 508 of the air spring installation 521.

The air distributor module 508 includes a pressure sensor 516, which detects a level of the pressure in the air distributor module 508. The pressure sensor 516 is connected to the control device 500 of the compressed air supply installation 502 via a data connection 551. A pressure sensor signal can be transmitted by the pressure sensor 516 to the control device 500 via the data connection 551. The pressure sensor signal represents in particular the level of the pressure detected by the pressure sensor 516. The control device 500 is also connected to the compressing means 506 via control lines 552, so that the control device 500 can control the compressing means 506 via transmitted control commands. In particular, the control device 500 can control the compressing means 506 on the basis of the level, detected by the pressure sensor 516, of the pressure in the air distributor module 508.

The air distributor module 508 includes five 2/2-way solenoid valves. One of these 2/2-way solenoid valves is to a compressed air reservoir 515 of the compressed air supply installation 502. Compressed air can be temporarily stored in the compressed air reservoir 515 and used, for example, for filling air springs as required.

The remaining four 2/2-way solenoid valves are assigned as air spring valves to the four air springs 518, 520, 522, 524 respectively of the air spring installation 521.

Via the air distributor module 508, compressed air can thus be discharged from the compressing means 506 via the pneumatic main line 507 into the air springs 518, 520, 522, 524 by opening the air spring valves.

Two of the air springs 518, 522 are located on the front axle 534 of the vehicle 503 and the other two air springs 520, 524 are located on the rear axle 536 of the vehicle 503.

FIG. 5B schematically shows the compressed air supply installation 502 described in relation to FIG. 5A. FIG. 5B depicts the diversion of compressed air into the air spring 518, 520, 522, 524 which, in comparison with the pressures in the remaining air springs, has the greatest pressure difference to the pressure in the air dryer 110 and/or the air distributor module 508.

For this purpose, dry compressed air 552 is discharged from the compressing means 506 to the air distributor module 508 via the pneumatic main line 507. Furthermore, the air spring valve of the air spring 520 with a pressure having the greatest pressure difference to the pressure in the air distributor module 508 is opened.

In the case shown in FIG. 5B by way of example, the pressure in the air dryer 510 and in the air distributor module 508 is 12 bar. The pressure in the two air springs 518, 522 of the front axle 534 of the vehicle 503 is also 12 bar. However, the pressures of the air springs 520, 524 of the rear axle 536 of the vehicle 503 are lower than 12 bar and are in this case 6 bar and 8 bar, wherein the air spring 520, which is located to the right on the rear axle 536 of the vehicle 503, as viewed in the direction of travel, has a pressure of 6 bar. The air spring 520 located at the rear right on the rear axle 536 thus has the greatest pressure difference to the pressure in the air dryer 510 and is accordingly the first to be applied with compressed air.

As an alternative to only applying compressed air to a single air spring on each occasion, compressed air can also be applied to two air springs simultaneously. This is in particular preferred if two air springs are at substantially the same pressure.

Such an operating situation is shown by way of example in FIG. 5C. FIG. 5C schematically shows the compressed air supply installation 500 described in relation to FIG. 5A, wherein the diversion of compressed air 552 simultaneously into the two air springs 520, 524 of the rear axle 536 of the vehicle 503 is depicted.

In the operating situation shown here, the air dryer 510 has a pressure of 11 bar. The two air springs 518, 522 of the front axle 534 of the vehicle 503 likewise have a pressure of 11 bar. To reduce the pressure in the air dryer 510, dry compressed air 552 is discharged from the air dryer 510 via the pneumatic main line 507 into the air distributor module 508. The two air spring valves of the air springs 520, 524 of the rear axle 534 are opened, so that compressed air 552 can flow into the two air springs 520, 524 simultaneously. This lowers the pressure in the air dryer 510 in this example from 11 bar to 7 bar.

FIG. 5D schematically shows the compressed air supply installation 503 described in relation to FIGS. 5A to 5C, with the difference that FIG. 5D uses arrows to depict the compressed air supply installation 503 being vented into the surrounding atmosphere 550.

To vent the compressed air supply installation 503, the air spring valves in particular are closed. The exhaust valve of the exhaust 512 is subsequently opened to vent the compressed air supply installation 503.

In this process, the compressing means 506 can be activated in order to store a portion of the compressed air, so that less compressed air 552 is actually emitted into the surrounding atmosphere 550.

A corresponding operating situation is shown in FIG. 5E. FIG. 5E schematically shows the compressed air supply installation 500 described in relation to FIGS. 5A to 5D.

While the compressed air supply installation 500 is being vented, the compressing means 506 is activated in order to store a portion of the compressed air 552. A correspondingly smaller compressed air quantity 552′ is then emitted into the surrounding atmosphere 550, so that the noise level generated when venting the compressed air supply installation 500 can be further reduced.

The exhaust valve of the exhaust 512 may in turn optionally be opened and closed again multiple times in succession, so that the compressed air 552 is emitted into the surrounding atmosphere 550 in comparatively smaller compressed air quantities on each occasion.

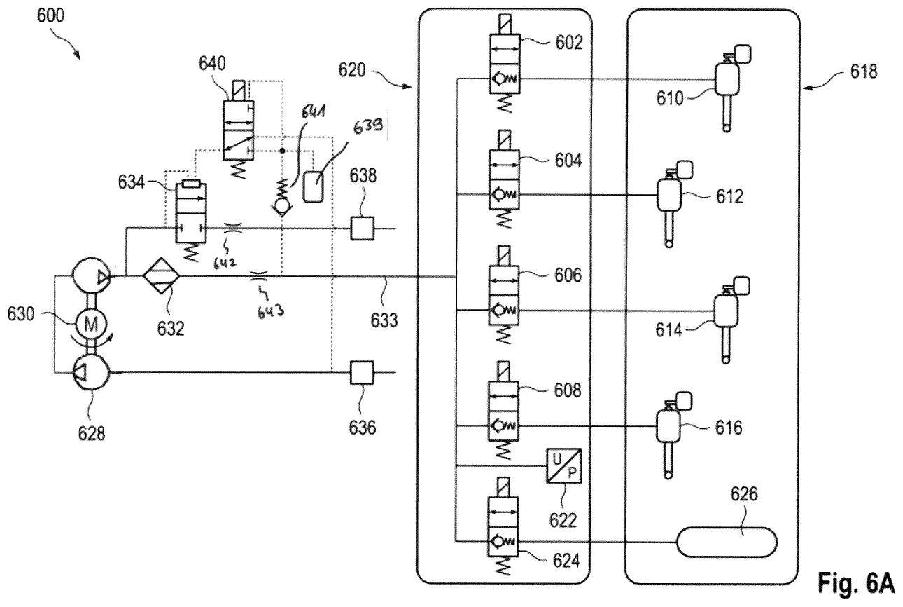

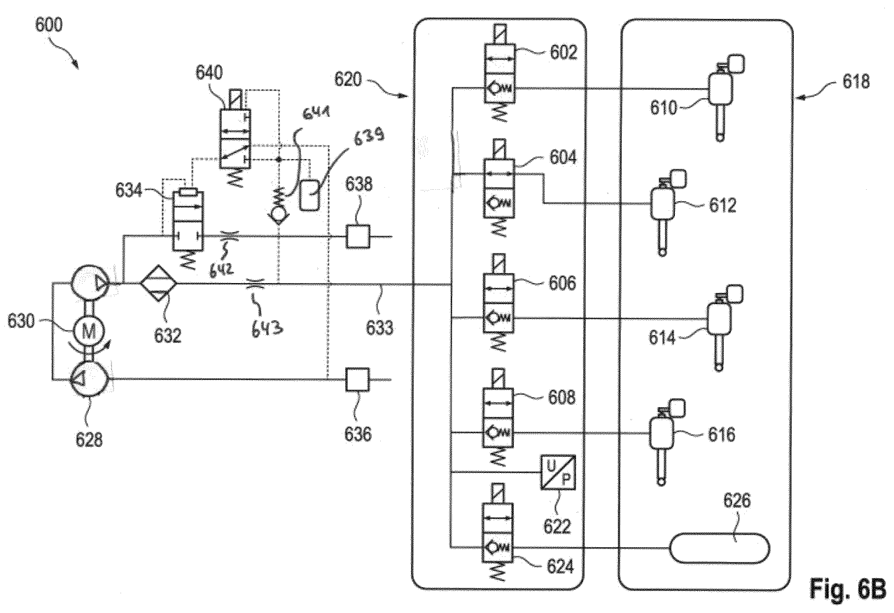

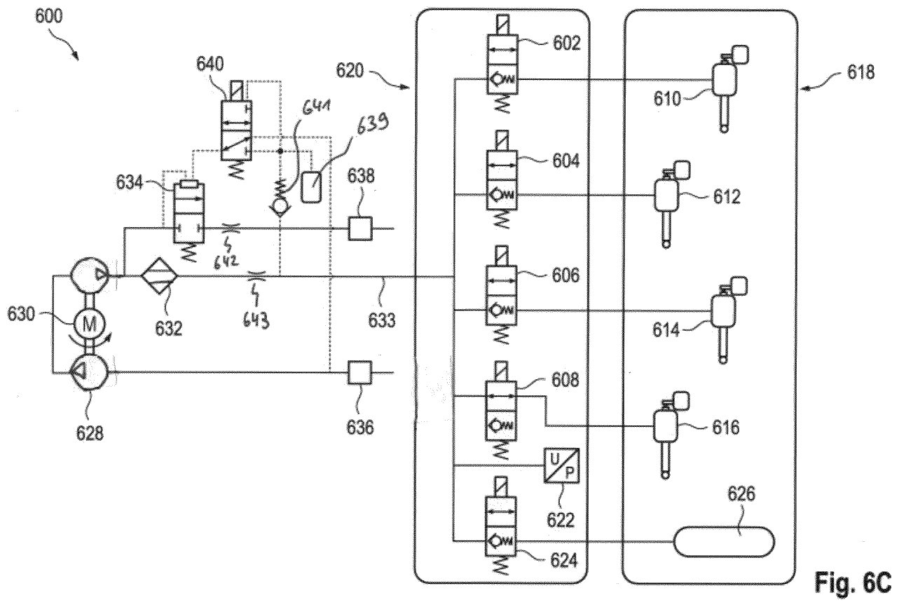

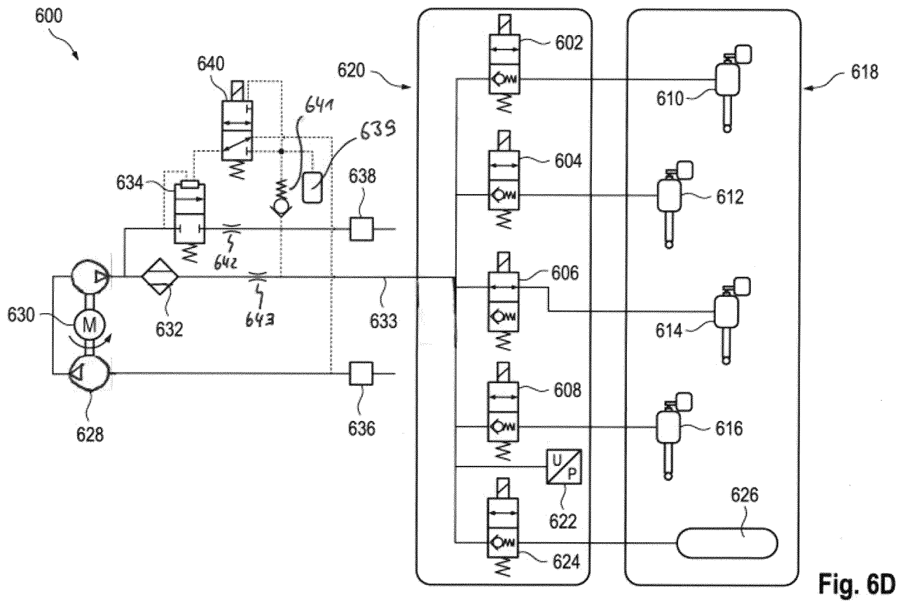

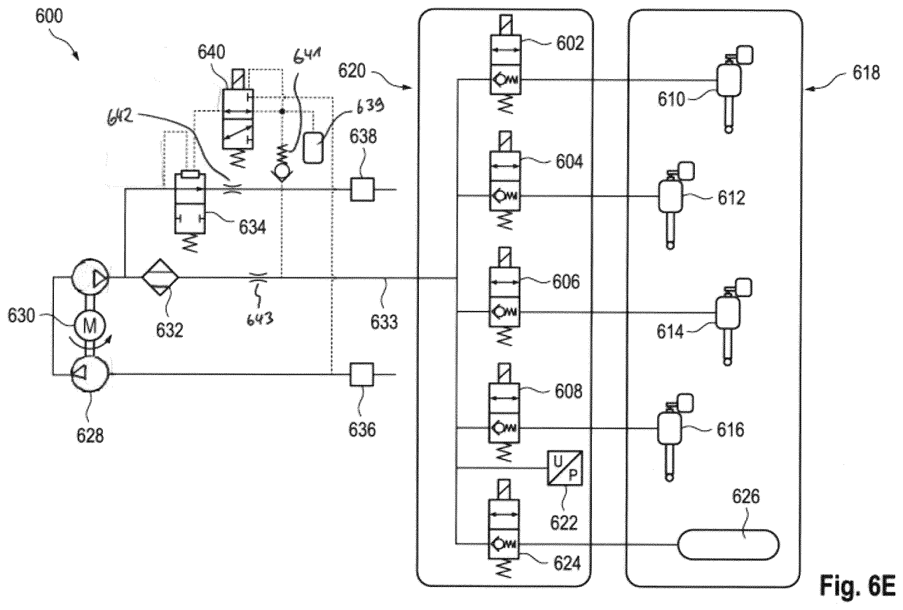

FIG. 6A shows a schematically illustrated compressed air supply installation 600, which is pneumatically connected to air springs 610, 612, 614, 616 of an air spring installation 618 via air spring valves 602, 604, 606, 608. The air spring valves 602, 604, 606, 608 are configured as 2/2-way solenoid valves and form part of an air distributor module 620.

The air distributor module 620 further includes a pressure sensor 622 for detecting a level of a pressure in the air distributor module 620, and a gallery 627 for distributing the compressed air to the air spring valves 610, 612, 614, 616.

The air distributor module 620 includes a further 2/2-way solenoid valve, which is a reservoir valve 624. A compressed air reservoir 626 is attached to the reservoir valve 624 and can be filled with compressed air via the latter. Compressed air may also be withdrawn from the compressed air reservoir 626 and discharged for example into the air springs 610, 612, 614, 616. By filling the air springs 610, 612, 614, 616 with compressed air, the vehicle can be raised relative to the ground.

The compressed air supply installation 600 also includes a compressing means 628, which has an electric motor 630 which can be used to drive, for example, pistons for compressing drawn-in air. During operation, compressed air is then discharged from the compressing means 628 via an air dryer 632 and via a pneumatic main line 633 to the air distributor module 620. Compressed air dried by the air dryer 632 is thus distributed to the air springs 610, 612, 614, 616 and the compressed air reservoir 626 via the air distributor module 620. The compressing means 628 draws in air from the surrounding atmosphere via an intake 636 provided with a filter. The filter prevents the compressing means 628 from being contaminated by particles.

The compressed air supply installation 600 also includes a relay valve 634, which is pneumatically connected to the compressing means 618 and the air dryer 632. The relay valve 634 is in turn pneumatically connected to an exhaust 638, which is equipped with silencers. The silencers make it possible to prevent the noise level from exceeding a specified threshold when the compressed air supply installation 600 is vented. By filling the air springs with compressed air, the pressure at the exhaust can be reduced to such an extent that it is possible to completely or at least partially dispense with silencers.

The compressed air supply installation 600 also includes an intermediate volume 639, to which compressed air can be applied via a valve 640 in order to lower the pressure in the air dryer 632 further. A check valve 641 is also provided. The compressed air supply installation 600 also has throttles 642, 643.

To supply air to and vent the compressed air supply installation 600, an intake or exhaust valve is activated accordingly by a control device of the compressed air supply installation 600.

FIGS. 6B to 6E show the compressed air supply installation 600 described in relation to FIG. 6A in different operating situations in each case.

FIG. 6B shows the compressed air supply installation 600 described in relation to FIG. 6A, wherein the air spring valve 604 of a first air spring 612 is open in order to divert compressed air into the first air spring 612. The first air spring 612 is located in a vehicle to the right on the front axle, as viewed in the direction of travel.

FIG. 6C shows the compressed air supply installation 600 described in relation to FIGS. 6A and 6B in an operating situation in which the air spring valve 608 of a second air spring 616 is open in order to divert compressed air into the second air spring 616. The second air spring 616 is located in a vehicle to the right on the rear axle, as viewed in the direction of travel.

FIG. 6D shows the compressed air supply installation 600 described in relation to FIGS. 6A to 6C, in a further operating situation in which the air spring valve 606 of a third air spring 614 is open in order to divert compressed air into the third air spring 614. The third air spring 614 is located in a vehicle to the left on the rear axle, as viewed in the direction of travel.

As can be seen from FIGS. 6B to 6D, in the respective operating situation, only one of the air spring valves 602, 604, 606, 608 is open at any time and the remaining air spring valves 602, 604, 606, 608 are closed. Compressed air from the air dryer 632 and/or the air distributor module 620 is thus applied to the air springs 610, 612, 614, 616 individually in a chronologically consecutive manner.

In this process, each of the air springs 610, 612, 614, 616 is filled in each case with compressed air in a specified compressed air quantity and/or for a predefined period of time.

The excess compressed air from the air dryer 632 and/or the air distributor module 620 is thus distributed in portions to the air springs 610, 612, 614, 616. Compressed air is applied to the air springs 610, 612, 614, 616 in a chronologically consecutive manner in particular until the excess compressed air from the air dryer 632 and/or the air distributor module 620 is distributed to the air springs. The compressed air quantity of the excess compressed air is determined in particular in accordance with the amount by which the pressure in the air dryer 632 and/or the air distributor module 620 has to be reduced so that, at the exhaust 638, a pressure prevails which does not result in a noise level above a specified threshold when the compressed air supply installation 600 is vented into the surrounding atmosphere.

FIG. 6E shows the compressed air supply installation 600 described in relation to FIGS. 6A to 6D in an operating situation in which all air spring valves 602, 604, 606, 608 are closed and the relay valve 634 and the exhaust 638 for venting the compressed air supply installation 600 are open. Since the excess compressed air was distributed to the air springs 610, 612, 614, 616 before venting, the pressure at the exhaust 638 is comparatively low, so that venting the compressed air supply installation 600 does not result in a noise level above a specified threshold.

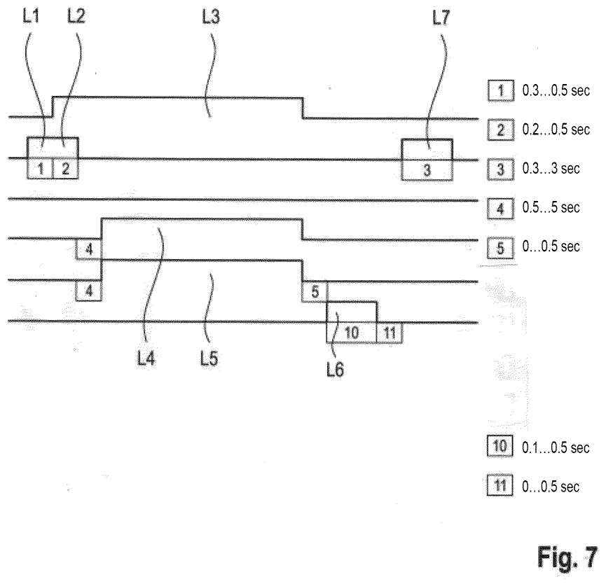

FIG. 7 shows a logic diagram which represents a sequence of steps when filling air springs with compressed air.

The intake valve is initially opened for a period of time of 0.3 seconds to 0.5 seconds (step L1), so that air from the surrounding atmosphere can flow into the compressed air supply installation. The intake valve then remains open for a further 0.2 seconds to 0.5 seconds (step L2). The compressing means is activated (step L3) during this period of time in order to draw in air from the surrounding atmosphere. The steps L2 and L3 begin simultaneously. However, the compressing means remains activated even when the intake valve is closed again.

After the intake valve is closed for 0.5 seconds to 5 seconds, the boost valve (step L4) and the air spring valves of the air springs of the front axle of the vehicle (step L5) are opened simultaneously. The air spring valves of the air springs of the rear axle of the vehicle remain closed during this period of time.

In the logic diagram described here, it is assumed that the pressure in the air springs of the rear axle is lower than the pressure in the air springs of the front axle. The boost valve is optional and could also either remain closed or even be absent from the compressed air supply installation.

After the air spring valves of the air springs on the front axle of the vehicle have been closed again, after 0 seconds to 0.5 seconds the air spring valves of the air springs of the rear axle are opened (step L6) in order to fill the air springs of the rear axle with compressed air. In the logic circuit diagram described here by way of example, compressed air is applied to the air springs of the rear axle for a period of time of 0.1 seconds to 0.5 seconds.

After the air spring valves of the air springs on the rear axle have been closed again, after 0 seconds to 0.5 seconds the exhaust valve is opened (step L7) for a period of time of 0.5 seconds to 3 seconds in order to vent the compressed air supply installation.

By discharging compressed air into the air springs of the front axle and the rear axle of the vehicle, the level of the pressure at the exhaust valve can be reduced accordingly. It is then possible to vent the compressed air supply installation at a comparatively lower pressure, so that the noise level generated when venting is accordingly also comparatively lower.

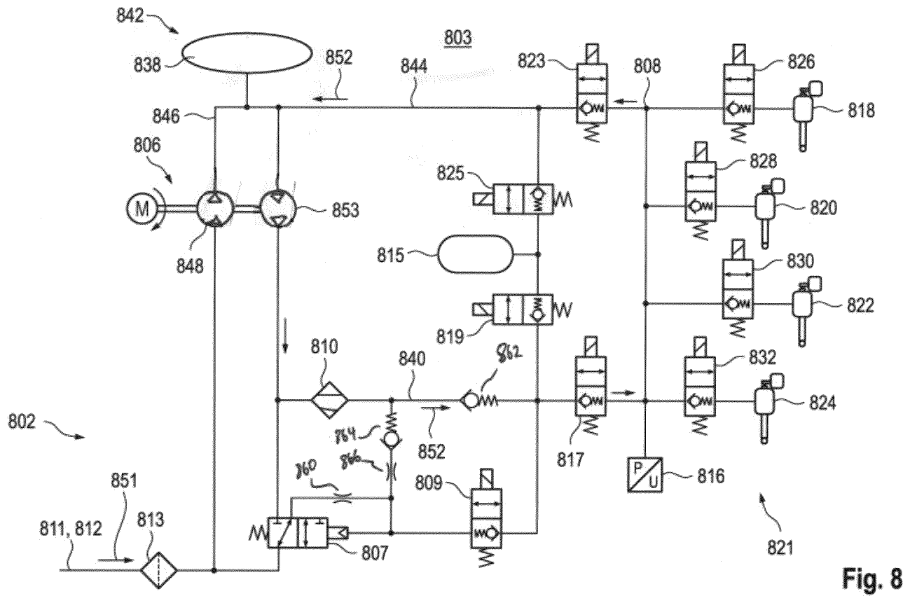

FIG. 8 schematically shows a compressed air supply installation 802, which is pneumatically connected to an air spring installation 821, is realized as a closed system and has an auxiliary storage means 838.

The compressed air supply installation forms part of a vehicle 803.

The compressed air supply installation 802 includes an intake 811 and an exhaust 812 with a filter 813 for filtering drawn-in air 850. To draw in air 850, the compressed air supply installation 802 includes a compressing means 806. The air 850 is compressed by the compressing means 806 and is transferred as compressed air 851 to the air dryer 810 of the compressed air supply installation 802.

The dry compressed air 852 is transferred from the air dryer 810 to the air distributor module 808 via a pneumatic main line 840. A check valve 862 is provided in the pneumatic main line 840. The pneumatic main line 840 is also pneumatically connected to a relay valve 807 via a check valve 864 and throttles 860, 866. The air distributor module 808 includes four air spring valves 826, 828, 830, 832. In addition, the air distributor module 808 includes a pressure sensor 816 for measuring a level of the pressure in the air distributor module 808. The air distributor module 808 is connected in each case to the air springs 818, 820, 822, 824 via the air spring valves 826, 828, 830, 832. By opening the air spring valves 826, 828, 830, 832, compressed air from the compressed air supply installation 802 can thus be applied to the air springs 818, 820, 822, 824 of the air spring installation 821, for example in order to raise the vehicle 803 relative to the ground.

In order to divert compressed air 852 into the air distributor module 808, a separating valve 817, which is positioned upstream and is configured as a 2/2-way solenoid valve, is opened.

Additionally or alternatively, the compressed air 852 could also be discharged into a compressed air reservoir 815 of the compressed air supply installation 802 by opening a reservoir valve 819.

Compressed air 852, which is to be conveyed from the air distributor module 808 back in the direction of the exhaust 812, flows through a return flow valve 823, which is also configured as a 2/2-way solenoid valve. Compressed air 825 flowing through the return flow valve 823 can be discharged into the compressed air reservoir 815 via a booster valve 825. Alternatively or additionally, compressed air 852 flowing through the return flow valve 823 can be discharged into an intermediate volume 838. By discharging the compressed air 852 into the intermediate volume 838, the level of the pressure at the exhaust 812 can be additionally reduced. To vent the compressed air supply installation 802, the latter also includes an exhaust valve 809 and a relay valve 807, both of which are configured as a 2/2-way solenoid valve. The compressed air supply installation 802 can then be vented at a comparatively lower pressure.

It is understood that the foregoing description is that of the preferred embodiments of the invention and that various changes and modifications may be made thereto without departing from the spirit and scope of the invention as defined in the appended claims.

### LIST OF REFERENCE SIGNS [PART OF THE DESCRIPTION]

1, 1′ compressing means port
2, 2′ compressed air supply port
3, 3′ exhaust
50, 50′ surrounding atmosphere
51, 51′ drawn-in air
52, 52′ compressed air
53, 53′ compressed air
54, 54′ compressed air
55, 55′ data connection
56, 56′ control lines
100, 100′ control device
101, 100′ vehicle
102, 102′ compressed air supply installation
103, 103′ pneumatic system
106, 106′ compressing means
108, 108′ air distributor module
110, 110′ air dryer
111, 111′ intake valve
112, 112′ exhaust valve
116, 116′ pressure sensor
118, 120, 122, 124, 118′, 120′, 122′, 124′ air springs
121, 121′ air spring installation
126, 128, 130, 132, 126′, 128′, 130′, 132′ air spring valves
129 gallery
131 pneumatic main line
300 graph
302 compressed air quantity emitted into the surrounding atmosphere
304 pressure at the exhaust
306, 308, 310 curves
312 arrow
314 first pressure sub-range
316 second pressure sub-range
500 control device
502 compressed air supply installation
503 vehicle
506 compressing means
507 pneumatic main line
508 air distributor module
510 air dryer
511 intake
512 exhaust
515 compressed air reservoir
516 pressure sensor
518, 520, 522, 524 air springs
521 air spring installation
534 front axle
536 rear axle
550 surrounding atmosphere
551 data connection
552 compressed air
552′ smaller compressed air quantity
555 control line
600 compressed air supply installation
602, 604, 606, 608 air spring valves
610, 612, 614, 616 air springs
618 air spring installation
620 air distributor module
622 pressure sensor
624 reservoir valve
626 compressed air reservoir
627 gallery
628 compressing means
630 electric motor
632 air dryer
634 relay valve
636 intake
638 exhaust
640 exhaust valve
802 compressed air supply installation
803 vehicle
806 compressing means
808 air distributor module
810 air dryer
811 intake
812 exhaust
813 filter
815 compressed air reservoir
816 pressure sensor
817 separating valve
818, 820, 822, 824 air springs
819 reservoir valve
821 air spring installation
823 return flow valve
825 booster valve
826, 828, 830, 832 air spring valves
838 auxiliary storage means
840 pneumatic main line
850 drawn-in air
851 compressed air
852 compressed air
860 throttle
862 check valve
864 check valve
866 throttle
S1 setting the compressing means to idle mode
S2 closing the exhaust valve
S3 opening the air spring valves
S4 establishing an equilibrium pressure
S5 closing the air spring valves
S6 opening the exhaust valve
T1 setting the compressing means to idle mode
T2 closing the exhaust valve
T3 specifying the compressed air quantity and/or a period of time
T4 applying compressed air to first air spring
T5 applying compressed air to second air spring
T6 applying compressed air to third air spring
T7 applying compressed air to fourth air spring
T8 filling the air springs again
T9 activating the compressing means
T10 opening the exhaust valve
L1 opening the intake valve
L2 keeping the intake valve open
L3 activating the compressing means
LA activating the booster valve
L5 filling the air springs of the front axle for a predefined period of time
L6 filling the air springs of the rear axle for a predefined period of time
L7 opening the exhaust valve

1. A method for operating a pneumatic system having a compressed air supply and an air spring arrangement pneumatically connected to the compressed air supply, for a vehicle, wherein:
the compressed air supply has a pneumatic main line and an air dryer in the pneumatic main line, and the pneumatic main line has a compressor port to a compressor, and a compressed air supply port to an air distributor module, wherein:
the air spring arrangement has a plurality of air springs, which are pneumatically connected via a gallery of the air spring arrangement;
the pneumatic system has a control device for controlling the compressed air supply and the air spring arrangement; and, wherein the method comprises:
before the compressed air supply is vented, activating the compressed air supply via the control device in such a way that compressed air is discharged from the air dryer and/or the air distributor module into a first air spring of the air spring arrangement with an exhaust valve closed and the compressor inactive;
ascertaining the first air spring to be the air spring having a greatest pressure difference to a pressure in the air dryer or the air distributor module before the compressed air is discharged from the air dryer and/or the air distributor module;
initially discharging compressed air from the air dryer and/or the air distributor module into the air spring ascertained to be the first air spring; and,
chronologically following the discharge of compressed air into the first air spring and discharging the compressed air remaining in the air dryer and/or the air distributor module into a second air spring of the air spring arrangement and/or an intermediate volume.

2. The method of claim 1, wherein, after compressed air has been applied to the first and second air springs, a residual compressed air from the air dryer and/or the air distributor module is vented through an exhaust into a surrounding atmosphere.

3. The method of claim 2, wherein, chronologically after the compressed air is discharged into the air springs and before compressed air is vented from the air dryer and/or the air distributor module through the exhaust into the surrounding atmosphere, compressed air is discharged from the air dryer and/or the air distributor module into the intermediate volume.

4. The method of claim 2, wherein compressed air from the air dryer is applied to the first and second air springs when a pressure sensor initially measures a level of pressure in the air distributor module of one of the following: less than 12 bar; less than 11 bar; less than 10 bar; and, between 0 bar and 12 bar.

5. The method of claim 2, wherein the compressed air supply is activated by the control device in such a way that the compressed air is discharged into the first and second air springs in a specified compressed air quantity and/or for a specified period of time.

6. The method of claim 2, wherein, after the first and second air springs have been filled, compressed air from the air dryer and/or the air distributor module is subsequently discharged into remaining ones of the air springs, wherein, in each case, the air spring with a pressure which, in comparison with pressures of the other remaining air springs, has the greatest difference to the pressure in the air dryer and/or in the air distributor module, is filled with the compressed air in a chronologically consecutive manner.

7. The method of claim 3, wherein, in accordance with an order of the air springs ascertained based on a greatest pressure difference to a pressure in the air dryer and/or in the air distributor module, compressed air from the air dryer and/or the air distributor module is applied to the air springs again in a same order in a chronologically consecutive manner, in a specified compressed air quantity and/or for a predefined period of time in each case.

8. The method of claim 2, wherein a compressed air quantity is individually specified for each of the air springs and the compressed air supply is activated by the control device in such a way that the compressed air is discharged into a corresponding one of the air springs in a compressed air quantity specified in each case.

9. The method of claim 2, wherein a period of time is individually specified for each of the air springs and the compressed air supply is activated by the control device in such a way that the compressed air is discharged into a corresponding one of the air springs for the period of time specified in each case.

10. The method of claim 3, wherein the first air spring is located on a different vehicle axle to the second air spring, and the compressed air is applied to the first air spring and the second air spring in each case together with further air springs of a same vehicle axle.

11. The method of claim 9, wherein, when a pressure of the air springs of a front axle of the vehicle is greater than a pressure of the air springs of a rear axle of the vehicle, compressed air is discharged from the air springs of the front axle into the air springs of the rear axle before venting.

12. The method of claim 10, wherein, when a pressure of the air springs of a rear axle of the vehicle is greater than a pressure of the air springs of a front axle of the vehicle, compressed air is discharged from the air springs of the rear axle into the air springs of the front axle before venting.

13. The method of claim 1, wherein the compressed air supply is activated by the control device in such a way that the exhaust valve is opened and closed again at predefined intervals, so that the compressed air supply is vented in steps through an exhaust.

14. The method of claim 1, wherein the compressed air supply is activated by the control device in such a way that the compressor stores a portion of the compressed air while compressed air is being vented through an exhaust, so that the compressed air supply is vented at a comparatively lower pressure difference into a surrounding atmosphere.

15. The method of claim 1, wherein the compressed air supply comprises an auxiliary storage unit, and before the compressed air supply is vented, compressed air from the air dryer and/or the air distributor module is applied, as well as to the air springs, to the auxiliary storage unit in a specified compressed air quantity and/or for a predefined period of time.

16. A pneumatic system comprising a compressed air supply and an air spring arrangement having air springs and being pneumatically connected to the compressed air supply, wherein the pneumatic system has a control device for controlling the compressed air supply and the air spring arrangement and is configured to carry out a method including the steps of:
before the compressed air supply is vented, activating the compressed air supply via the control device in such a way that compressed air is discharged from an air dryer and/or an air distributor module into a first air spring of the air spring arrangement with an exhaust valve closed and a compressor inactive;
ascertaining the first air spring to be the air spring having a greatest pressure difference to a pressure in the air dryer or the air distributor module before the compressed air is discharged from the air dryer and/or the air distributor module;
initially discharging compressed air from the air dryer and/or the air distributor module into the air spring ascertained to be the first air spring; and,
chronologically following the discharge of compressed air into the first air spring and discharging the compressed air remaining in the air dryer and/or the air distributor module into a second air spring of the air spring arrangement and/or an intermediate volume.

17. The pneumatic system of claim 16, wherein the compressed air supply includes the following: a compressed air reservoir, the compressor, the air distributor module, the air dryer, an intake with an intake valve and the exhaust with an exhaust valve for filling from a surrounding atmosphere and venting into the surrounding atmosphere, and a pressure sensor for detecting a level of a pressure in the air distributor module, wherein the control device is configured to control the compressed air supply and the air spring arrangement to carry out the method.

18. A vehicle comprising a pneumatic system including a compressed air supply and an air spring arrangement including air springs and being pneumatically connected to the compressed air supply, wherein the pneumatic system has a control device for controlling the compressed air supply and the air spring arrangement and being configured to carry out a method including the steps of:
before the compressed air supply is vented, activating the compressed air supply via the control device in such a way that compressed air is discharged from an air dryer and/or an air distributor module into a first air spring of the air spring arrangement with an exhaust valve closed and a compressor inactive;
ascertaining the first air spring to be the air spring having a greatest pressure difference to a pressure in the air dryer or the air distributor module before the compressed air is discharged from the air dryer and/or the air distributor module;
initially discharging compressed air from the air dryer and/or the air distributor module into the air spring ascertained to be the first air spring; and,
chronologically following the discharge of compressed air into the first air spring and discharging the compressed air remaining in the air dryer and/or the air distributor module into a second air spring of the air spring arrangement and/or an intermediate volume.

19. The vehicle of claim 18, wherein said vehicle is a passenger car.
